(19) United States
(12) Patent Application Publication
(10) Pub. No.: US 2025/0003538 A1
(43) Pub. Date: Jan. 2, 2025

(54) Rotary Joint with Sensor Port and Method

(71) Applicant: Kocsis Technologies, Inc., Alsip, IL (US)

(72) Inventor: Mark Francis Carroll, Manhattan, IL (US)

(21) Appl. No.: 18/216,933

(22) Filed: Jun. 30, 2023

(51) Int. Cl. B22D 11/00; B22D 11/16

(52) U.S. Cl. CPC F16L 27/0828; F16L 27/087

(57) ABSTRACT

A rotary joint is disclosed having a head, a non-rotating component, and a rotating component. The head has a first fluid channel and a sensor port on an exterior of the head in communication with the first fluid channel. The non-rotating component is connected to the head and has a second fluid channel in communication with the first fluid channel. The rotating component is mounted to rotate about the non-rotating component.

### FIELD OF THE INVENTION

This invention relates in general to rotary joints.

### BACKGROUND OF THE INVENTION

Caster rolls are used in a continuous casting process for forming metal. The caster rolls can support, form, and guide the metal during the process. Prior rotary joints for caster rolls have a number of disadvantages, such as a lack of an exterior location to deploy a sensor for detecting a characteristic of the fluid within the rotary joint.

### SUMMARY OF THE INVENTION

A rotary joint is disclosed. In some embodiments, the joint has a head, a non-rotating component, and a rotating component. The head has a first fluid channel and a sensor port on an exterior of the head in communication with the first fluid channel. The non-rotating component is connected to the head and has a second fluid channel in communication with the first fluid channel. The rotating component is mounted to rotate about the non-rotating component.

A method of monitoring a fluid characteristic of a fluid in a caster roll is disclosed. A sensor is mounted to a sensor port on an exterior of a head of a rotary joint. The sensor port is in fluid communication with a first fluid channel of the head. The rotary joint is deployed in a bore of the caster roll where a rotating component of the rotary joint is in the bore. The rotating component is rotatable about a shaft of the rotary joint. The shaft is connected to the head. Fluid flows through the first fluid channel. A fluid characteristic of the fluid in the first fluid channel is detected with the sensor.

Numerous other advantages and features of the present invention will become readily apparent from the following detailed description of the invention and the embodiments thereof, from the claims, and from the accompanying drawings.

### BRIEF DESCRIPTION OF THE DRAWINGS

FIG. 1 is a perspective front view of an embodiment of a rotary joint of the invention.

FIG. 2 is a front view of the rotary joint of FIG. 1.

FIG. 3 is a side view of the rotary joint of FIG. 1.

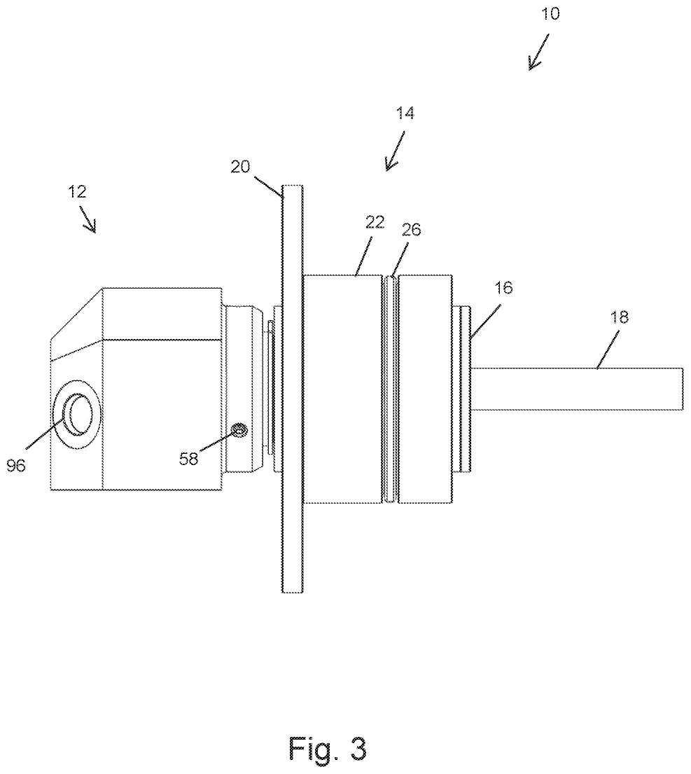

FIG. 4 is a side section view of the rotary joint of FIG. 1 taken along plane 4-4 of FIG. 2.

FIG. 5 is a bottom view of the rotary joint of FIG. 1.

FIG. 6 is a bottom transparent view of a head of the rotary joint of FIG. 1.

FIG. 7 is a perspective front view of a sensor port of the head of the rotary joint of FIG. 1.

FIG. 8 is a side view of a sensor usable with the rotary joint of FIG. 1.

FIG. 9 is a side section view of the rotary joint of FIG. 4 deployed in a caster roll.

FIG. 10 is a side section view of the rotary joint and portions of the caster roll of FIG. 9 with one end of the caster roll comprising a plug.

FIG. 11 is a front perspective view of a portion of the head of the rotary joint of FIG. 1 with a port plug.

FIG. 12 is a side perspective view of the port plug of FIG. 10.

### DETAILED DESCRIPTION

The following description is presented to enable any person skilled in the art to make and use the invention. For the purposes of explanation, specific nomenclature is set forth to provide a plural understanding of the invention. While this invention is susceptible of embodiment in many different forms, this description describes and the drawings show specific embodiments of the invention with the understanding that the present disclosure is to be considered as an exemplification of the principles of the invention and is not intended to limit the invention to the specific embodiments illustrated.

A rotary joint 10 is disclosed. The joint 10 comprises a head 12, a rotating component or journal gland 14, a non-rotating component or shaft 16, and a conduit 18. The head is connected to the shaft 16. The head 12 is non-rotating. The journal gland 14 is mounted to rotate about the non-rotating component. The conduit 18 extends within the shaft and into the head.

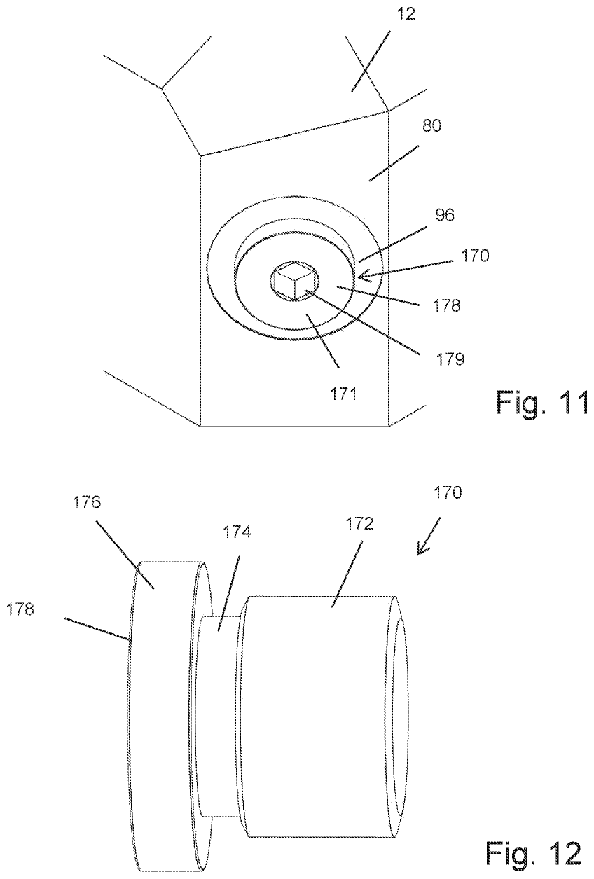

The rotary joint to a caster roll 21 in the bore 23 of the caster roll 21, such as shown in FIG. 10. The caster roll is used to support, form, and guide hot metal slabs in a continuous casting process. Rotary joint 10 facilitates the supply of cooling fluid to caster roll 21.

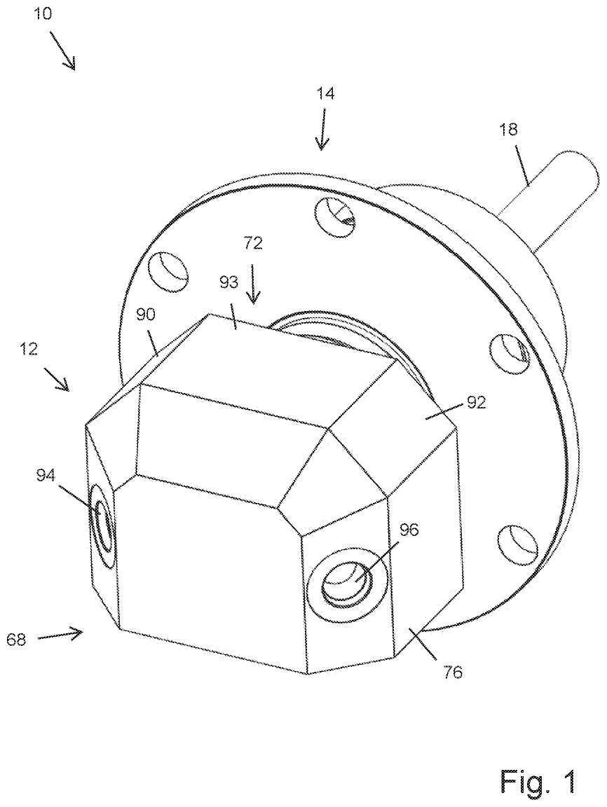

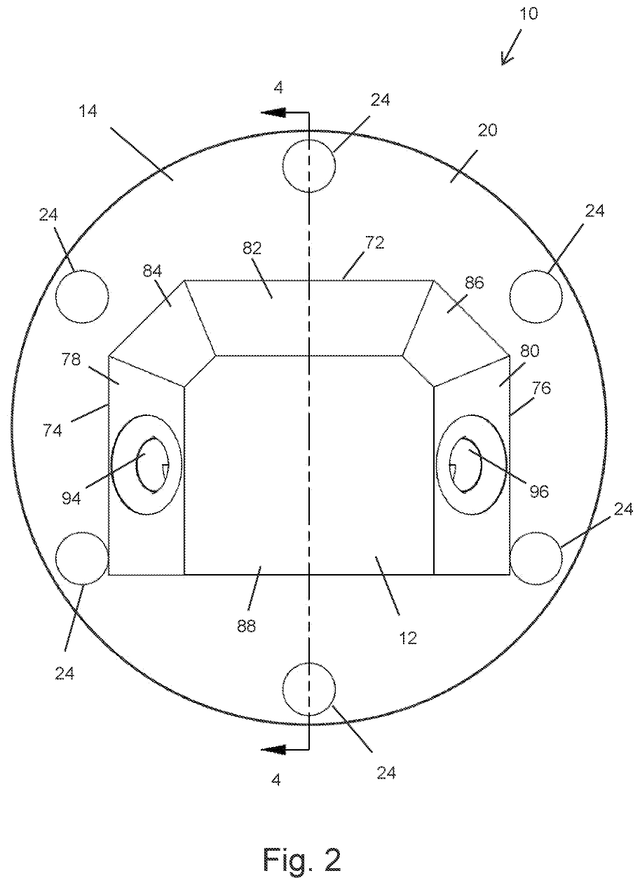

The journal gland 14 comprises an end flange 20 and a gland portion 22. The end flange is radially larger than the gland portion 22. The end flange comprises a plurality of fastener apertures 24 that are adjacent to a perimeter of the end flange 20 as shown in FIGS. 1 and 2. Fasteners 15, such as bolts, can be placed at the apertures 24 to secure the journal gland 14 and the rotary joint 10 to a caster roll 21, such as shown in FIG. 10. The fasteners can fix the end flange 20 to the end 25, such as the end face, of a caster roll 21, with the gland portion 22 extending into the bore 23 of the caster roll 21, such as shown in FIG. 10. The fasteners may engage threaded apertures (not shown) of the end 25 of the caster roll 21. The gland portion 22 comprises a o-ring groove for receiving an o-ring 26. The o-ring 26 seals the gland portion 22 to the bore 23 of the caster roll 21 when the gland portion 22 is within the bore 23. The journal gland 14 rotates with the rotation of the caster roll 21 when mounted to the caster roll.

The journal gland 14 is mounted to rotate on the shaft 16. The gland 14 comprises seal recesses 28, 30 that receive rotary seals 32, 34 between the gland 14 and the shaft 16. The rotary seals 32 seals the area between the seals 32, 34 where the gland 14 interfaces with the shaft 16 from external contamination. Seal 34 seals internal pressure between the seals 32, 34 where the gland 14 interfaces with the shaft 16. The rotary seals may either rotate with or under the influence of a rotation of the gland 14 or may be stationary. In some embodiments, the seals comprise a sealing component 36 and a resilient component 38. In some embodiments, the sealing component may comprise Teflon and the resilient component may comprise steel or stainless steel. The resilient component acts as an energizer to ensure the seal maintains contact with the gland 14 and the shaft 16.

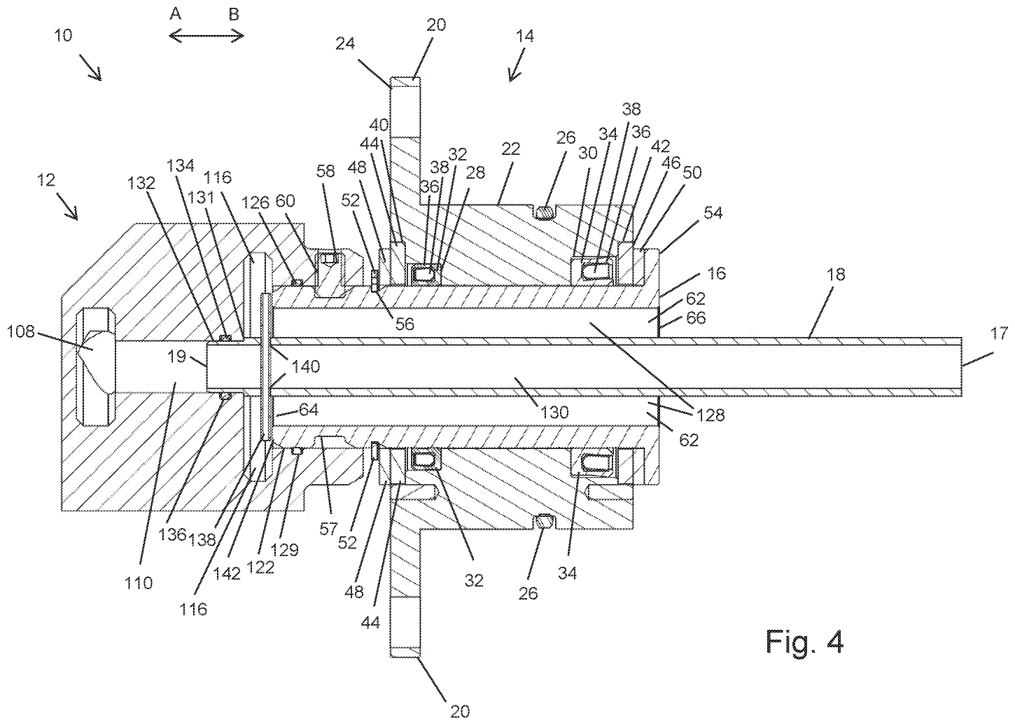

Adjacent the seal recesses 28, 30 and the seals 32, 34 are split journal recesses 40, 42, and split journal glands 44, 46 at opposite axial ends of the journal gland 14. The split journal glands 44, 46 enclose the seals 32, 34 within the seal recesses 28, 30 at opposite ends of the journal gland 14. The split journal glands 44, 46 are radially larger than the seals, as shown in FIG. 4.

Adjacent the split journal glands 44, 46 at opposite axial ends of the split journal glands 44, 46, are thrust bearings 48, 50. The thrust bearings rotate with the shaft and support axial load of or provided via the journal gland 14, and reduce wear between the gland and shaft. Adjacent the thrust bearing 48 is a retaining ring 52. Adjacent the thrust bearing 50 is an end flange 54. The retaining ring 52 is seated and axially contained within a retaining ring groove 56 in the shaft 16. The end flange 54 is radially larger than the remaining portions of the shaft 16, as shown in FIG. 4. The journal gland 14 is contained against axial movement along the shaft 16 between the end flange 54 and the retaining ring 52.

The shaft comprises a setscrew groove 57 adjacent the retaining ring groove 56 opposite the end flange 54, as shown in FIG. 4. The head 12 is connected or fixed to the shaft by one or more set screws 58 and three set screws are shown in the figures. The set screw comprises outer threads that engage cooperating threads of a set screw bore 60 perimeter wall in the head 12. When the set screw(s) extends from the set screw bore 60 into the groove 56 or is seated in the groove 56, the shaft 16 is axially fixed to the head 12 and is fixed against rotation relative to the head 12.

The shaft 16 comprises a bore 62. The bore extends through the shaft along its axial length between a front opening 64 and a rear opening 66.

The head comprises a front 68, a bottom 70, a top 72, a first side 74, and a second side 76. The front comprises a plurality of front chamfers 78, 80, 82, 84, 86 and a front face 88. The front chamfers transition between the front face 88 and the side 74, 76, top 72, and top chamfers 92, 90. The top chamfers 90, 92 transition between the top face 93 and the sides 74, 76. While the head 12 is shown as comprising a generally rectangular shape in the figures, the head may comprise other shapes, with or without chamfers.

The head 12 comprises at least one sensor port 94 on an exterior of the head. In some embodiments, the head comprises a first sensor port 94 and a second sensor port 96 on an exterior of the head. In some embodiments, one or more or all of the ports 94, 96 are on a front 68 of the head, such as the front face 88 or on a chamfer 78, 80 of the front, as shown in FIG. 2. In some embodiments, one or more or all of the ports 94, 96 are located on one or more of the bottom 70, top 72, first side 74, second side 76, or chamfers 82, 84, 86, 90, or 92. In some embodiments, the sensor ports allow at least a portion of the sensor, such as sensor 160, to extend outside of the head 12. In some embodiments, the location of the ports 94, 96 on the exterior of the head allow the sensors to be conveniently connected to, installed, maintenance, removed, and/or exchanged at the sensor ports.

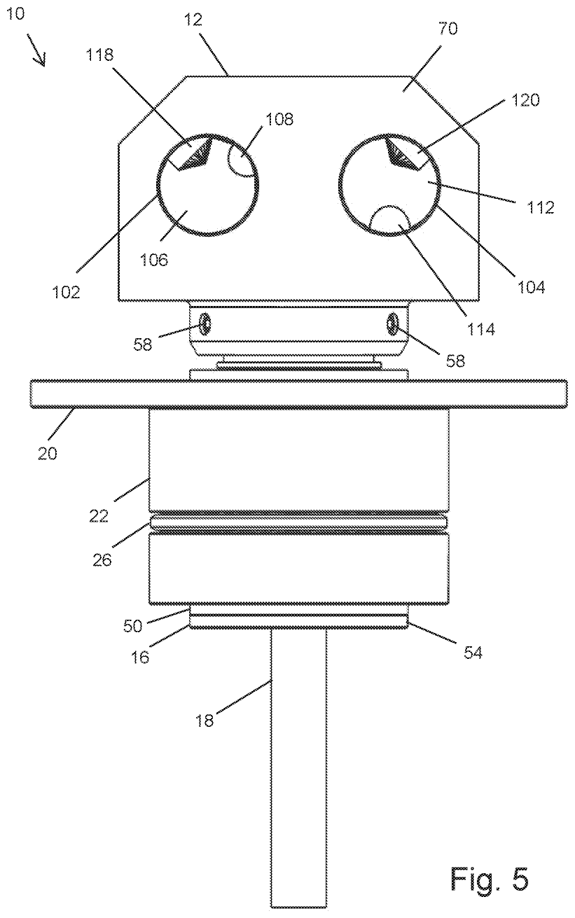

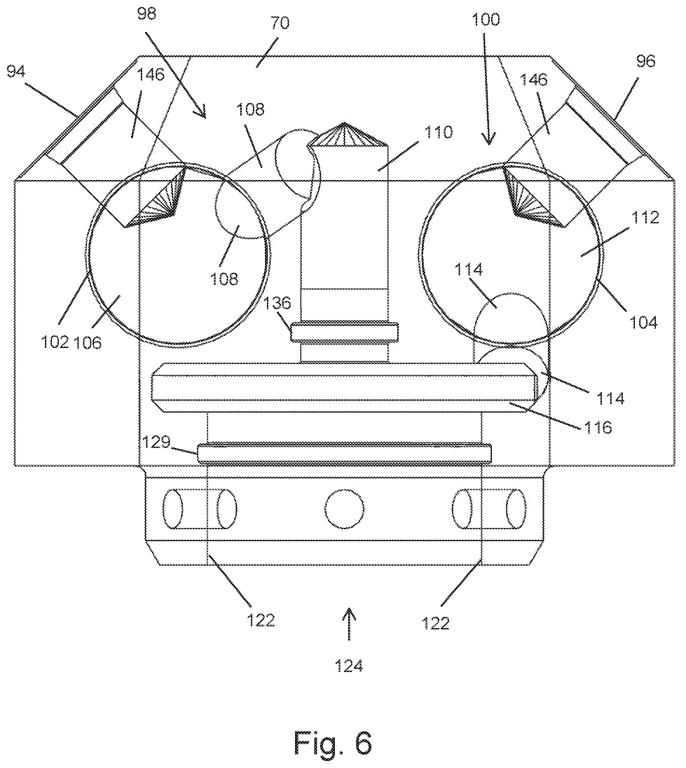

The head comprises at least one fluid channel and, in some embodiments, a plurality of fluid channels, comprising a first fluid channel 98 and a second fluid channel 100, such as shown in FIGS. 6, 5, and 4. The first fluid channel 98 is fluid communication connected to a first fluid port 102 that is open on the bottom 70 of the head 12, as shown in FIGS. 5 and 6. The second fluid channel 100 is in fluid communication connected to second fluid port 104 that is open on a bottom 70 of the head 12, as shown in FIGS. 5 and 6. In some embodiments, the first fluid channel 98 is an inflow fluid channel, the first fluid port 102 is a fluid inlet port, the second fluid channel 100 is an outflow fluid channel, and the second fluid port 104 is a fluid outlet port.

In some embodiments, the first fluid channel 98 comprises a plurality of first fluid channel segments 106, 108, 110. Segment 106 is fluid connected to and joins segment 108, and segment 108 is fluid connected to and joins segment 110. In some embodiments, the second fluid channel comprises a plurality of second fluid channel segments 112, 114, 116. Segment 112 is fluid connected to and joins segment 114, and segment 114 is fluid connected to and joins segment 116. In some embodiments, segment 116 is concentric with and has a diameter that is larger than a diameter of a head bore 122, as shown in FIG. 6.

The first sensor port 94 is in fluid communication with the first fluid channel 98 via a port channel 146 of port 94. Channel 146 of port 94 joins segment 106. The second sensor port 96 is in fluid communication with the second fluid channel 100 via a port channel 146 of port 96. The channel 146 of port 96 joins segment 112.

The head comprises the head bore 122 that is open to a back side 124 of the head opposite the front 68, as shown in FIG. 6. The head bore 122 extends from the back side 124 to segment 116 of the second fluid channel. A front of the shaft 16 is received into the head bore 122 as shown in FIG. 4. The shaft is fixed to the head within the head bore by the set screw(s) 58 seated in the set screw groove 57 of the shaft as described above and shown in FIG. 4. The front of the shaft 16 stops at or before the segment 116. An O-ring 126 is located in an o-ring groove 129 of the head about the bore 122. The o-ring 126 fluid seals the head to the shaft.

The conduit 18 extends through the bore 62 of the shaft 16 and divides the bore into a plurality of fluid channels 128, 130. The fluid channel inside the conduit is fluid channel 130. The fluid channel within the bore 62 but outside of the conduit is fluid channel 128.

As shown in FIG. 4, the front of the conduit 18 comprises a shoulder 131 between a first portion 132 and a remaining portion of the conduit. The first portion 132 has a narrower outside diameter than the remaining portion of the conduit. The first portion 132 is received into the segment 110. An o-ring 134 is housed in a o-ring groove 136 of the head to fluid seal the conduit 18 to the segment 110. The conduit 18 and fluid channel 130 are open to segment 110 and the first fluid channel 98 of the head.

The conduit 18 is secured against axial movement in the direction A of FIG. 4 toward the head by the engagement of the shoulder 131 with the corresponding wall of the head at segment 116 as shown in FIG. 4. The larger diameter portion of the conduit after the shoulder 131 is too large to fit in the smaller diameter of segment 110, but the first portion 132 of the conduit has an outside diameter sized to fit in segment 110.

A pin 138, such as a slotted spring pin, extends through the conduit via apertures 140 in the conduit 18, as shown in FIG. 4. The pin engages or is adjacent a front face 142 of the shaft 16. The conduit is secured against axial movement in the direction B of FIG. 4 away from the head by the engagement of the pin to the conduit 18 and the front face 142 of the shaft 16.

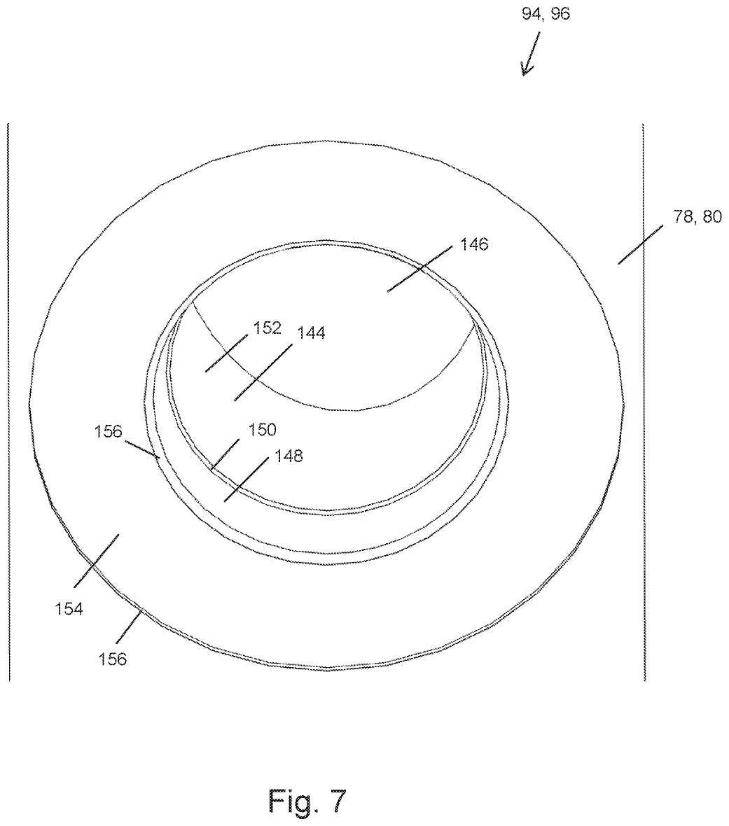

FIG. 7 shows sensor ports 94, 96, each of which are the same. The ports 94, 96 comprise one or more interior perimeter wall(s) 144 defining a port channel 146 of the port, which allows fluid communication through the port, unless and to the extent that the port is plugged or occupied by a sensor. In some embodiments, the perimeter wall 144 comprises threads (not shown). In some embodiments, the perimeter wall comprises a front portion 148, a step 150, and a second portion 152. The front portion 148 comprises an enlarged diameter as compared to the second portion 152. The step 150 transitions between portions 148, 152. In some embodiments, the step is perpendicular to portions 148 and 152.

In some embodiments, the ports 94, 96 comprise a recessed perimeter face 154 surrounding the perimeter wall 144 and port channel 146. There is a chamfer 156 between the recessed perimeter face 154 and the surrounding wall of the chamfer 78, 80. In some embodiments, there is a chamfer 156 adjacent the wall 144 and more specifically between the recessed perimeter face 154 and the wall 144 or front portion 148, as shown in FIG. 7. An o-ring seal, such as seal 168 of the sensor 160, may engage the recessed perimeter face 154, the chamfer 156, and/or a portion of the wall 144 to seal the connection between the sensor and the port. In some embodiments, sensor ports 94, 96 are configured as hydraulic fluid ports according to a standard, such as the National Pipe Thread (NPT), National Pipe Thread Fuel (NPTF), or SAE J1926-1 and ISO 11296-1, or other fluid port standards. The ports 94, 96 are configured to create a fluid tight connection with a sensor 160 or a plug 170 when a sensor or plug is deployed at the port 94, 96.

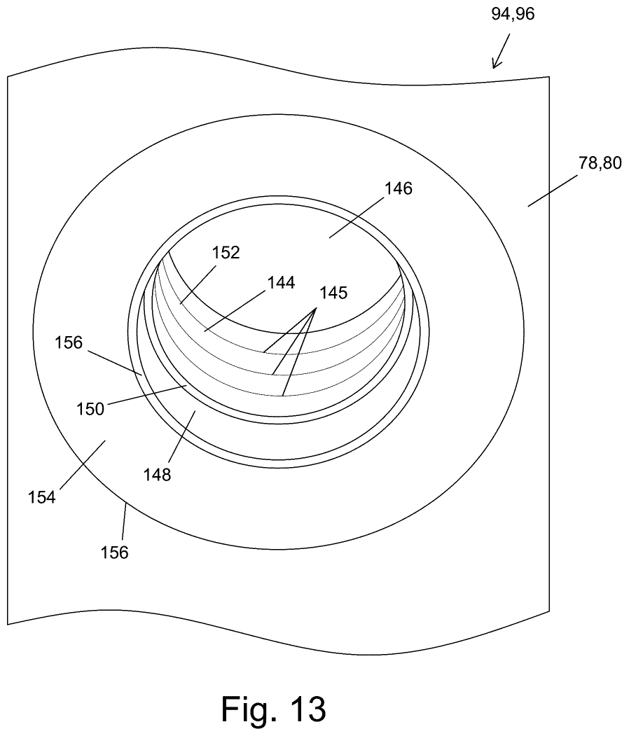

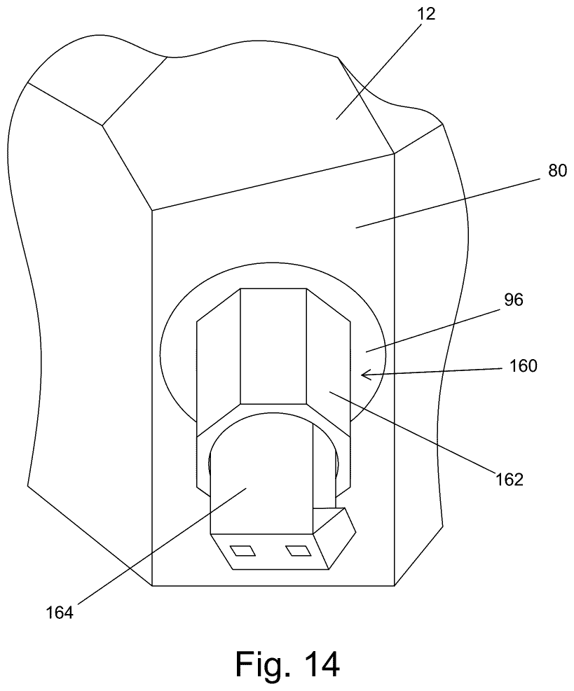

In some embodiments, a port plug 170 can be used at one or both ports 94, 96, when a sensor is not deployed at the port(s), such as shown in FIGS. 11 and 12. An exemplary port plug 170 is shown closing and sealing port 96 in FIG. 11. The plug has a threaded perimeter wall 172 (threads not shown) that is configured to engage the threads of perimeter wall 144 of the port to fluidly seal the port closed, until the port is needed. The plug may also comprise a seal (not shown) at or about the threaded perimeter wall, such as in groove 174 to fluid seal the port closed. The groove 174 is between the head 176 and the perimeter wall 172. The head 176 may comprise an engageable recess in the front face 171 with an engageable perimeter wall(s) 179. For example, the engageable perimeter wall(s) may comprise six walls configured to engage an allen or hexagonal head or tool for inserting or removing the plug from the port.

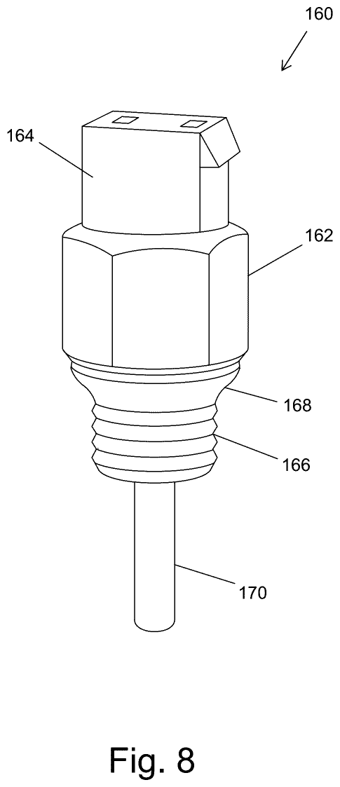

An exemplary sensor 160 that can be deployed at one or both ports 94, 96 is shown in FIG. 8, yet other sensors can be used. The sensor comprises a body with a nut shaped exterior 162, a plug 164, a threaded portion 166, a seal 168, and a probe 170. The probe 170 extends from the threaded portion. The plug extends from the exterior 162 opposite the probe. The threads of the threaded portion 166 engage the threads of the perimeter wall 144 of the port, 94, 96 to secure the sensor to the port. The probe extends into the port, and into the channels 146 and, in some embodiments, into segments 106, 112. In some embodiments, the probe does not extend as long or past the threaded portion 166. The threaded portion 160 and/or the seal 168 fluid seal the port 94, 96 closed when the sensor is seated in the port.

In some embodiments, the sensor is a temperature sensor configured to measure temperature, and in particular fluid temperature, at or adjacent the port 94, 96 within the head. When the temperature reported by the sensor meets or exceeds a predefined value, such temperature may indicate a failure of or a problem with the rotary joint, the corresponding caster roll, the fluid coolant system or parts thereof. In some embodiments, the temperature sensor has a temperature sensing range of −40 degree Celsius (C) to 125 degrees C.

In some embodiments, sensor is a pressure sensor or pressure transducer configure to measure fluid pressure at or adjacent the port 94, 96. In some embodiments, a pressure sensor is provided at both ports 94, 96 and the pressures reported by both sensors are compared to determine the difference between the pressure reported at the first sensor and the pressure reported at the second sensor. When the pressure difference between the sensors meets or exceeds a predefined value, such pressure differential may indicate a failure of or a problem with the rotary joint, the corresponding caster roll, the fluid coolant system, or parts thereof. Therefore, sensors, such as temperature sensors or pressure sensors can be used at the port(s) 94, 96 to monitor the status, health, and/or state of operation of the rotary joint, the corresponding caster roll, and/or the fluid coolant system. In some embodiments, the sensor is configured for wireless communication, such as via WIFI, Bluetooth, Cellular, or other protocols, and can send data from the sensor wirelessly to a receiver.

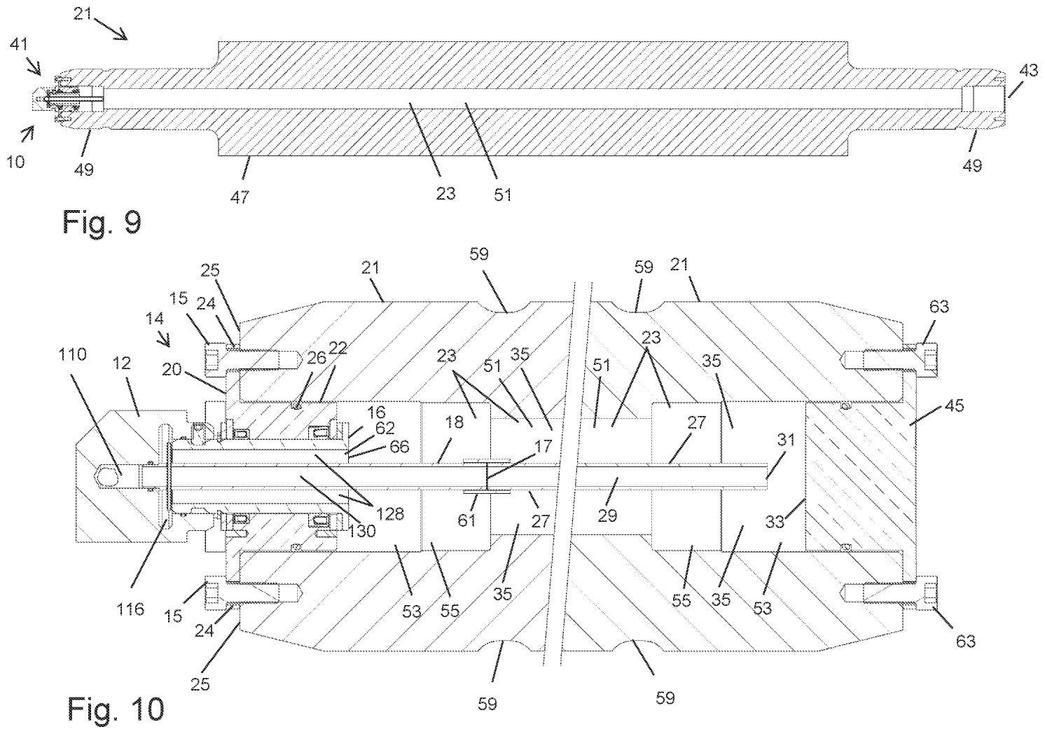

FIGS. 9 and 10 show the rotary joint deployed in an exemplary caster roll 21. The caster roll comprises a bore 23 extending axially through the roll 21 between a first end opening 41 and a second end opening 43. The rotary joint is deployed in the first end opening. In some applications, the second end opening is closed by a bore plug 45 (not shown in FIG. 9). The caster roll may comprise a central main portion 47 and end portions 49. The main portion 47 may be radially larger than the end portions 49. In some applications, the end portions 53, 55 of the bore 23 are radially larger than an intermediate portion 51 of the bore 23. In some applications, the first end portion 53 is radially larger than the second end portion 55. The caster roll may be mounted to rotate at the end portions 49 and at or about recesses 59 in the end portions 49. While FIGS. 9 and 10 show an exemplary caster roll, the rotary joint may be deployed in other caster rolls.

The rotary joint 10 is a part of a fluid circuit, which may be a cooling fluid circuit for cooling the caster roll 21 or for otherwise maintaining the caster roll 21 at a predefined temperature or temperature range. Fluid enters the head 12 of the rotary joint 10 from a fluid source at the fluid port 102. A fluid pump (not shown) maybe provided upstream of the head to pump the fluid into the head. The fluid travels in and through the first fluid channel 98, including in segments 106, 108, and 110. The fluid enters the front 19 of the conduit 18 from the segment 110. The fluid travels through the conduit 18 in channel 130. The fluid exits the channel 130 and conduit at the back end 17 of the conduit. In some embodiments, a second conduit 27 is connected to the first conduit 18 at the back end 17 with a coupling 61 as shown in FIG. 10. In such case the fluid travels in the channel 29 of conduit 27 and out the back end 31 of the conduit 27. The fluid is blocked from further travel away from the rotary joint by the terminal end wall 33 of the bore plug 45 that closes the bore 23 at the second end opening 43 of the caster roll 21. The bore plug 45 may be fixed in the bore and to the caster roll by fasteners 63, such as bolts, as shown in FIG. 10. The flow of fluid is then directed and flows along a return path. The return path comprises a return channel 35, the fluid channel 128 of the shaft 16, and the second fluid channel 100. The return channel 35 is the area within the bore 23 outside of the conduits 18, 27. The fluid flows along the return channel 35, the channel 128, the segments 118, 114, 112, and out the fluid port 104. In some applications, the fluid may then be recycled and pumped back to the fluid port 102 to complete the fluid circuit. The fluid may also pass one or more intermediate components (not shown) before returning back to fluid port 102. In some embodiments, a second conduit 27 is not used, and the return path begins at the end 17 of conduit 18. The conduit(s) 18, 27 may comprise a length desired for corresponding to the length of the caster roll where the conduit(s) are to be used.

The fluid entering the head at port 102 is in fluid communication with the first sensor port 94, and any sensor deployed at the port 94. The fluid about to exit the head at port 104 is in fluid communication with the second sensor port 96, and any sensor deployed at the port 96. Therefore, fluid characteristics, such as temperature, pressure, or others, can be detected at or adjacent inlet port 96 and at or adjacent outlet port 96 by an adjacent sensor at ports 94 and/or 96. Such fluid characteristics can be reported via the sensors to an operator or other appropriate person who can attend to maintenance of the fluid circuit, the rotary joint, the caster roll, and/or components thereof. The fluid characteristics can be reported via the sensors to a connected or remote computing device that is configured to record the data report by the sensor(s) and/or to notify the operator or other appropriate person.

From the foregoing, it will be observed that numerous variations and modifications may be affected without departing from the spirit and scope of the invention. It is to be understood that no limitation with respect to the specific apparatus illustrated herein is intended or should be inferred. For example, one or more component embodiments may be combined, modified, removed, or supplemented to form further embodiments within the scope of the invention. Further, steps could be added or removed from the processes described. Therefore, other embodiments and implementations are within the scope of the invention.

1. A rotary joint, comprising:
a head comprising an exterior, a first fluid channel, a fluid port, and a sensor port, the fluid port and the sensor port are each on the exterior and each in communication with the first fluid channel;
a non-rotating component connected to the head and comprising a second fluid channel in communication with the first fluid channel; and,
a rotating component mounted to rotate about the non-rotating component.

2. The joint of claim 1, wherein the sensor port comprises a perimeter wall, and the perimeter wall comprises threads.

3. (canceled)

4. The joint of claim 1, wherein the first fluid channel is an inflow channel, the sensor port is a first sensor port, the fluid port is a fluid inlet port; and the head comprises an outflow channel, a fluid outlet port and a second sensor port, the fluid outlet port and the second sensor port are each on the exterior and are each in communication with the outflow channel.

5. The joint of claim 1, comprising a conduit, the non-rotating component comprises a bore, the conduit is within the bore and divides the bore into a plurality of fluid channels, the plurality of fluid channels comprises the second fluid channel, the conduit forming one of the plurality of fluid channels.

6. The joint of claim 1, wherein the first fluid channel comprises a plurality of first segments, each first segments of the plurality of first segments is in communication with the other first segments of the plurality of first segments.

7. The joint of claim 1, wherein the sensor port is located at a front of the head.

8. The joint of claim 1, comprising a sensor mounted to the sensor port.

9. The joint of claim 8, wherein the sensor is a temperature sensor.

10. The joint of claim 8, wherein the sensor is a pressure sensor.

11. The joint of claim 1, wherein
the head comprises a head bore, and the non-rotating component is received in the head bore, the head is fixed to the non-rotating component at the head bore;
the first fluid channel is a fluid inflow channel, the sensor port is a first sensor port, and the rotary joint comprises a fluid outflow channel and a second sensor port at the exterior in communication with the fluid outflow channel;
the fluid port is a fluid inlet port, the head comprises a fluid outlet port and the fluid inlet port on a bottom of the head, the fluid outlet port in communication with the fluid outflow channel; and,
the joint comprising a conduit, the non-rotating component is a shaft, the shaft comprises a shaft bore, the conduit is within the shaft bore and divides the shaft bore into a plurality of fluid channels, the plurality of fluid channels comprise the second fluid channel and a third fluid channel, the conduit forming the second fluid channel, the third fluid channel is in communication with the fluid outflow channel.

12. The joint of claim 11, comprising a pin; the conduit is fixed between an interior wall of the head and the shaft; the pin intersects the conduit at a front of the non-rotating component to prevent the conduit from moving away from the head.

13. The joint of claim 1, wherein the non-rotating component comprises a cylindrical portion, a groove, and a flange; the cylindrical portion between the groove and the flange, the rotating component mounted to rotate on the cylindrical portion and is axially contained between the groove and the flange.

14. The joint of claim 1, comprising a plurality of seals; the rotating component comprises a plurality of seal grooves, the plurality of seals are located in the corresponding seal grooves between the rotating component and the non-rotating component.

15. A rotary joint for use in a bore of a caster roll to supply the caster roll with cooling fluid, comprising:
a head comprising an exterior, a first fluid channel, a fluid port, and a sensor port, the fluid port and the senor port are each on the exterior and each in communication with the first fluid channel;
a shaft connected to the head and comprising a second fluid channel in communication with the first fluid channel; and,
a journal gland mounted to rotate about the shaft.

16. The joint of claim 15, wherein the first fluid channel is an inflow channel, the sensor port is a first sensor port, the fluid port is a fluid inlet port; and the head comprises an outflow channel, a fluid outlet port, and a second sensor port, the fluid outlet port and the second sensor port are each on the exterior and are each in communication with the outflow channel.

17. The joint of claim 15, comprising a conduit, the shaft comprises a shaft bore, the conduit is within the shaft bore and divides the component bore into a plurality of fluid channels, the plurality of fluid channels comprises the second fluid channel, the conduit forming one of the plurality of fluid channels.

18. A method of monitoring a fluid characteristic of a fluid in a caster roll, comprising:
mounting a sensor to a sensor port on an exterior of a head of a rotary joint, the sensor port in fluid communication with a first fluid channel of the head;
deploying the rotary joint in a bore of the caster roll where a rotating component of the rotary joint is in the bore, the rotating component is rotatable about a shaft of the rotary joint, and the shaft is connected to the head;
flowing a fluid through the first fluid channel; and,
detecting a fluid characteristic of the fluid in the first fluid channel with the sensor.

19. A method of claim 18, wherein the first fluid channel is a fluid inflow channel, the sensor is a first sensor, the sensor port is an first sensor port, and the fluid characteristic is a first fluid characteristic; and the step of mounting comprises mounting a second sensor to a second sensor port on the exterior of the head, the second sensor port in fluid communication with a fluid outflow channel of the head; and the step of detecting comprises the step of detecting a second fluid characteristic of the fluid in the fluid outflow channel with the second sensor.

20. The method of claim 19, wherein the first fluid characteristic and the second fluid characteristic is a fluid pressure or a fluid temperature.
